(19) United States
(12) Patent Application Publication
(10) Pub. No.: US 2009/0211657 A1
(43) Pub. Date: Aug. 27, 2009

(54) BUBBLE-TOLERANT MICRO-MIXERS

(75) Inventor: Holger Dirac, Birkeroed (DK)

Correspondence Address: MCCORMICK, PAULDING & HUBER LLP, CITY PLACE II, 185 ASYLUM STREET, HARTFORD, CT, 06103, US

(73) Assignee: Danfoss A/S, Nordborg (DK)

(21) Appl. No.: 11/720,866

(22) PCT Filed: Dec. 8, 2005
(86) PCT No.: PCT/DK05/00775

§ 371 Date: Jun. 5, 2007

(30) Foreign Application Priority Data
Dec. 8, 2004 (DK) PA 200401901

(51) Int. Cl. G05D 7/01; G05D 11/02; B01F 3/08; F15D 1/00

(52) U.S. Cl. 137/896; 137/605; 137/599.12; 138/40

(57) ABSTRACT

A device for mixing at least one first fluid and one second fluid in a micro-flow system, comprising at least two flow restrictors, a first transfer conduit in fluid communication the first og said fluids and a recipient, at least one second transfer conduit in fluid communication with the second of said fluids, the second transfer conduit having at least two fluid outlets in fluid communication with said first transfer conduit, where each of said outlets of said second transfer conduit is downstream and in fluid communication with the outlet of one of said flow restrictors, and wherein the flow restrictors are bubble-tolerant, being formed to prevent fragmentation of bubbles entering the flow restrictor, into a bubble train consuming the pressure difference between the source and the recipient. Pumping means may be attached to the flow system, possibly being constant-pressure pumps of the kind, where elastomer bladders squeeze a fluid into the channels.

### CROSS REFERENCE TO RELATED APPLICATIONS

This application is entitled to the benefit of and incorporates by reference essential subject matter disclosed in International Patent Application No. PCT/DK2005/000775 filed on Dec. 8, 2005 and Danish Patent Application No. PA 2004 01901 filed Dec. 8, 2004.

### FIELD OF THE INVENTION

The present invention relates to mixing of fluids in a micro-flow system, without any risk of bubbles clogging the flow paths and thereby destroying the reliability of the mixing. The mixer comprises transfer conduits like capillary tubes or channels engraved on the surface of a plate. The fluids are merged in a laminated manner. Flow restrictors are inserted into the transfer conduits to ensure stable flow rates, but also possess the ability to segment gas bubbles passing the flow restrictors into sizes unable to clog the flow paths.

### BACKGROUND OF THE INVENTION

Systems with flows in the order of micro-litres per minute are often realized by connecting a source of pressurized liquid to transfer conduits like capillary tubes or channels engraved into the surface of a plate. In the following the transfer conduits shall freely be referred to as channels. This system of channels often comprises changing internal dimensions like a very abrupt narrowing to regulate the flow rates.

It is a known practical problem of such small-scale flow systems, that gas dissolved in a liquid may form into bubbles of gas in the liquid, and such bubbles may have a serious impact on the pressure difference or pressure drop required to drive the fluid at a given flow rate, and in the worst case bubbles may lead to an effective blocking of the channels. This is due to the phenomenon of fragmentation of a (larger) bubble into a plurality of small bubbles within the channel, a phenomenon being especially pronounced at the inlet of an internal narrowing of the channel.

Plugs of liquid separate the small bubbles from each other, and each small bubble requires a certain pressure difference between its ends to move along the channel. That pressure difference is largely independent of bubble length. Bubbles shorter than a critical length have a tendency to situate themselves into the channels thereby blocking the flow. This critical length depends on elements like the viscosity of the liquid, the dimensions of the channels and of the flow.

Whether actual clogging will occur depends, of course, on the pressure margin, which is available for driving the flow. Clogging will occur only if the total pressure differential between the source and the recipient is consumed by the sum of pressure drops from a train of bubbles and liquid plugs.

For many applications it is desirable to mix fluids in the system. This would be the case when a reagent fluid is added to give some change indicative of the concentration of some species in the fluid, like a shift in colour detectable by an optical apparatus. One application is to analyse for glucose in human tissue for diabetics, where it may be a matter of life and death to give a fast and reliable measurement.

Therefore, a number of micro-mixers has been suggested based on lamination of the fluids to enhance the mixing by diffusion, like adding a first fluid to the second from the top and the bottom letting the diffusion occur across two contact areas, or the more complicated lamination described in DE 195 36 856, where the fluids are cut into a plural of small sections.

Such mixing by lamination may suffer severely if a bubble places itself so as to restrict the flow of one of the fluids, thereby changing the relative flow rates of the fluids. This would lead to a reduced mixing efficiency of the fluids, possibly mixing the fluids in the wrong relative quantities.

To minimize the effect of the bubbles on the flow rates in general microflow-systems one can insert flow restrictors of a substantially large resistance, making the relative effect of a bubble less pronounced. They may be chosen as small pieces of glass capillary tubes with a smaller internal diameter than the channels. The flow rates in capillary tubes have a well-defined relation to the length and diameter of the capillary, and to the pressure drop along the inside of the capillary. For a given pressure drop the flow rate may thus be fixed at a desired value by choosing a capillary of suitable length and diameter. A disadvantage of this practice is that such flow restrictors themselves tend to fragment the bubble, each fragmented bubble adding to the total flow resistance.

### SUMMARY OF THE INVENTION

This invention relates to simple mixing by laminating layers of fluids together, where a first fluid is merged to a second fluid from two sides, leading to a laminated flow structure of the fluids, a lamination process that may naturally be repeated to increase the number of laminated layers of fluids. The laminated fluids then follow a channel section of such a length, that diffusion ensures a sufficient mixing of the fluids, at least in the ideal situation.

However, if the fluids contain bubbles the flow rates may be affected as described previously, in a way that makes the mixing unpredictable and unreliable.

Based on this, it has now been found that, by suitably widening the inlet of the flow channel dependent on the desired flow rate, it is possible to control the timing of perturbation growth of the liquid film around gas bubbles in the channel, in such a manner that any bubble fragmentation is controlled to bubble lengths only longer than the critical length and thus posing no risk of blocking the capillary.

The objective of this invention is to create a reliable micro-mixer, where the fluids are laminated and mixed by simple diffusion, without the drawbacks of bubbles affecting the flow rates and thereby the laminations and the mixing.

This is achieved by a device for mixing at least one first fluid and one second fluid in a micro-flow system, comprising

at least two flow restrictors

a first transfer conduit in fluid communication the first og said fluids and a recipient,

at least one second transfer conduit in fluid communication with the second of said fluids, the second transfer conduit having at least two fluid outlets in fluid communication with said first transfer conduit,

where each of said outlets of said second transfer conduit is downstream and in fluid communication with the outlet of one of said flow restrictors, and wherein the flow restrictors are bubble-tolerant, being formed to prevent fragmentation of bubbles entering the flow restrictor, into a bubble train consuming the pressure difference between the source and the recipient.

Pumping means may be attached to the flow system, possibly being constant-pressure pumps of the kind, where elastomer bladders squeeze a fluid into the channels.

### BRIEF DESCRIPTION OF THE DRAWINGS

FIG. 1 shows a simple mixing configuration of two fluids in a micro flow system, and with an air-bubble inside one of the channels.

FIG. 2 shows a narrowing of a flow channel cutting an air-bubble into a plural of smaller bubbles.

FIG. 3 shows mixing of two fluids by laminating them into respectively two and three parallel sheets.

FIG. 4 shows a train of air-bubbles blocking the flow-passage of one of the channels.

FIG. 5 shows a flow restrictor with a tapered fluid-inlet.

FIG. 6 shows a preferred embodiment of the invention.

### DETAILED DESCRIPTION OF THE INVENTION

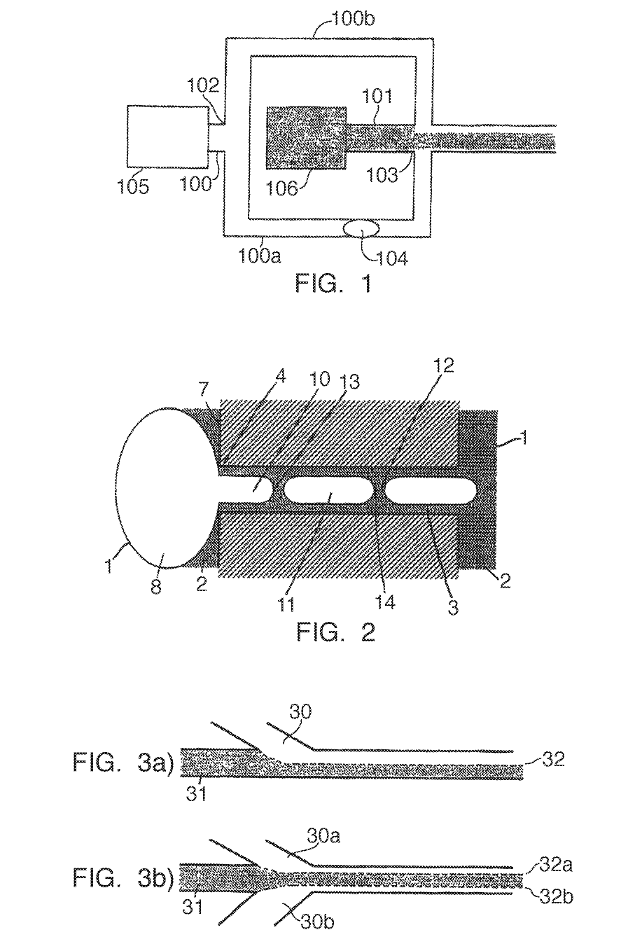

FIG. 1 illustrates the channel 100 receiving fluid from the reservoir 105, where the reservoir may be an elastomer bladder squeezing out the fluid, it may be a flexible reservoir placed in a pressurized container, or it may be any other means for storing a fluid and creating a flow.

A second channel 101 is communicating a second fluid from the reservoir 106, reservoir 106 in the preferred embodiment of the invention being identical to the reservoir 105, but this is not essential to the invention.

The first channel 100 is split at the point 102 into the branches 100a and 100b merging with the second channel 101 at a merging point 103 from the left and the right sides, respectively. The pressure drops by a factor DP=P102-P103, where P102 is the pressure in channel 100 just before the point of branching point 102, and P103 is the pressure in channel 101 just after the merging 103.

In the preferred embodiment of the invention, each of the two channels 100a, 100b has the same internal flow resistance R, and with the same drop in pressure DP, the flow rates are identical in the two channels 100a and 100b, so that Q100a/Q100b=1, where Q100a and Q100b are the flow rates in channels 100a and 100b respectively, being Q100a=DP/R=Q100b.

When a bubble 104 enters, for example the channel 100a, the resistance is affected by the perturbation DR lowering the flow rate Q100a,DR=DP/(R+DR), so that Q100a/Q100b=R/(R+DR)<1, since the perturbation DR is positive. Keeping constant flow conditions may often be vital when mixing fluids in analysis-systems, since, as described, bubbles of gas may have a predominant effect on the flow rates, when the internal resistance R is relatively small, but such fluctuations could be minimized by inserting substantially larger flow restrictors into the flow channels. If the perturbation is small compared to the resistance R, the relation Q100a,DR/Q100b approaches 1 since the two flow rates Q100a and Q100b becomes almost identical.

However, it is a well known phenomenon in the field of micro fluid systems with laminar flow that a structural change of the flow communicating means may lead to the formation or fragmentation of air-bubbles into sizes, where they will possibly clog the system. FIG. 2 illustrates a flow channel 1 having an inlet 4 to a narrowing section 3. At the inlet the section 3 forms an inlet face 7.

The liquid 2 may contain bubbles of gas 8. The bubble 8 is shown as being driven into the inlet 4 of the channel section 3 by the pressure difference between source and recipient. Often the presence of the bubble causes two-phase flow at the channel inlet 4. Liquid flows in a thin layer 9, which adheres to the inner surface of the channel 3. The liquid layer 9 coaxially surrounds a flow 10 of gas, which fills the remaining core of the channel 3.

The two-phase flow in the flow channel 3 exhibits a phenomenon of instability, which frequently leads to fragmentation of the gas flow into separate bubbles 11 of gas, separated by plugs 12 of liquid. This is due to the surface tension of the liquid-gas interface of the film 9. The surface tension causes a tendency of the liquid film to reduce its surface and may grow until a bubble is pinched off as indicated at 13 and 14. Such fragmentation is frequently observed, although in practice its onset has turned out to be largely unpredictable.

When sections of capillary tubes are inserted into the channels as flow restrictors, there will be a narrowing as illustrated on FIG. 2, which itself causes a bubble fragmentation, thereby adding to the problem of possible clogging.

For relatively large flows, more than a few micro-litres per minute, it is often sufficient to mix two fluids by simple diffusion, where the intermixing is often helped by a relative turbulent nature of the flows will exist post to the joining. In micro-system however, the conditions often are for the flows to be laminar, without such turbulent behaviour. So when the two flows 30,31 meet as illustrated on FIG. 3a, they will flow in a relatively laminated structure for a while, limiting the mixing to the surface of contact 32, thereby slowing down the mixing by diffusion. To increase the mixing times, the flows may be laminated into a plural of sheets, on FIG. 3b one of the fluids is split into two such sheets 30a, 30b, layered on the top and bottom of the first fluid 31 respectively. This doubles the contact area to 32a and 32b, and further reduces the depth of the diffusion, since the thickness of two of the layers 30a and 30b is smaller than the layer 31.

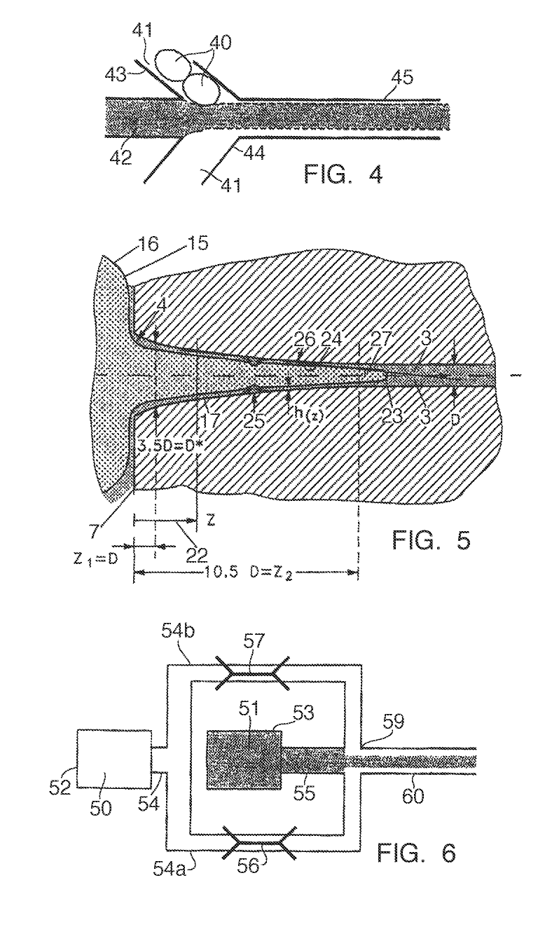

FIG. 4 illustrates what may happen when a train of bubbles 40 of a critical dimension enter a joining zone of two or more channels, where the two fluids 41, 42 merge from separate flow channels 43, 44 into a common mixing channel 45. If the total pressure differential between the source and the recipient is consumed by the sum of pressure drops from the train of bubbles 40, or almost consumed, then the bubbles 40 may be trapped in the channel 43, thereby preventing full flow of fluid 41 into the mixing channel 45, resulting in unreliable flows and mixing in the system.

Investigation has shown, however, that the flow restrictor geometry may be modified to suppress the generation of bubbles below critical length. Shown in FIG. 5, on a larger scale than in FIG. 1, is the inlet end of a flow restrictor of a similar overall construction as in FIG. 1. There is a difference, however, in that the flow channel 3 has been smoothly and gradually widened at the inlet to form the trombone-shaped inlet mouth. Near the inlet face 7, the channel is wide. Further away from the inlet face the channel narrows down toward the original internal diameter D. In terms of the coordinate z set at zero at the inlet face 7 and pointing in the direction of flow as indicated at 22, at z=D the channel has an internal diameter D(z)=3.5 D, and at z=10.5 D the channel has an internal diameter D(z)=D.

A first rule for the widening of the channel 3 may be derived from the condition that the inlet geometry should at least allow the formation of bubbles long enough to avoid blocking of the channel 3. Letting N denote the number of bubbles present in the flow restrictor, flow will not be blocked if

NΔP_{d}<ÄP

wherein ΔP_{d} denotes the deformation pressure drop of each bubble as defined in (3) above. Considering the pinch-off of a bubble in the widened part of the flow channel 3 at a point where the channel has an internal diameter D*>D, it has been calculated, that if

$${D}^{⋆} > \sqrt[3]{\frac{á {D}^{5}}{32 ç Q}} \qquad ( 1 )$$

and if the inlet of the channel 3 is widened to a diameter slightly above D*, this at least creates the possibility that bubbles produced by fragmentation will be long enough to not completely stop the flow through the channel, even if the channel is filled up completely by such bubbles. In the equation Q is the flow rate of liquid through the channel 3, η is the viscosity of the liquid and α is a frictional surface tension parameter, which must be established empirically.

Turning now to the fragmentation process itself, FIG. 2 shows a bubble 16 of gas 15 entering the channel 3. At the front 23 of the bubble, liquid is displaced by the gas to form a thin film 17 of thickness h(z) on the inner surface of the channel 3. Due the surface tension at the gas-to-liquid interface 24, the film 17 is unstable. The surface tension exerts a pumping action causing a tendency of the liquid to flow both radially and axially, as shown at 25, which is a well-known phenomenon in the field of hydrodynamics. This causes local accumulation of liquid, which may eventually lead to the formation of a plug of liquid, which fills the channel 3. Thus a smaller bubble 18 (not shown in FIG. 2) may be pinched off from the bubble 16.

Investigations indicate that it is largely a matter of local surface curvature and timing, whether pinch-off will actually occur or not. If the bubble 16 passes a site 25 of beginning local accumulation of liquid but the liquid film 17, however, not reach sufficient thickness to form a liquid plug while the bubble passes, pinch-off will not happen. On the other hand, if the liquid film 17 grows thick enough to coalesce at the centre of the channel 3 to form a liquid plug, while the bubble 16 flows past the site 25, pinch-off will be the result.

Based on this, it has now been found that by suitably widening the inlet of the flow channel dependent on the desired flow rate, it is possible to control the timing of perturbation growth of the liquid film around gas bubbles in the channel 3 in such a manner that any bubble fragmentation will lead to bubbles, which are either longer than the limiting length of equation 6, thus posing no risk of blocking the capillary, or short enough to reduce the flow, but not numerous enough to stop the flow of liquid through the capillary.

It is calculated that bubbles shorter than a limiting bubble length L_{bl},

$${L}_{bl} = \frac{\partial á {D}^{3}}{32 Q ( ç - {ç}_{g} )} ,$$

where η_{g} is the viscosity of the gas, lead to a risk of clogging the flow channel because the gain from lower viscosity of the gas is offset by the loss due to deformation; bubbles longer than L_{bl} will flow freely along the flow channel because the gain from lower viscosity of the gas dominates.

It has been found that within the tapered channel portion, instabilities will typically cause a liquid film to coalesce at the centre of the flow channel, and thereby to pinch off a bubble, and investigations indicate that the smallest of these local time periods, referred to as τ*, governs the time scale of bubble segmentation within the widened part of the channel 3.

It is desired to prevent bubble fragmentation into bubbles shorter than the limiting bubble length L_{bl}, and the characteristic (minimum) transit time τ_{bl} of such bubbles is

$${\hat{o}}_{bl} = {L}_{bl} / {v}^{⋆} ,$$

where v* is characteristic (maximum) value of bubble velocity at some coordinate z along the channel 3 where the internal diameter is at its minimum. A channel slope designed such that

$${\hat{o}}^{⋆} > {\hat{o}}_{bl} \qquad ( 2 )$$

will prevent the formation of bubbles having a length L_{b}<L_{bl}.

Relations (1) and (2) may then be combined in the design of the widened inlet to the channel 3 to form a flow restrictor which is tolerant to bubble fragmentation, as follows:

In a first section of the channel 3 between the inlet face 7 and a first z-coordinate z₁, the channel diameter D should be kept larger than the value D* given by relation (1) above. In this connection, the coordinate z₁ is defined as the first location along the channel where the channel diameter narrows down to D*. This will ensure that any bubble segmentation within the first section does not generate bubbles, which are so short as to block the flow completely.

In a second section of the channel, between the first z-coordinate z₁ and a second z-coordinate z₂, the channel should be designed to narrow down gradually towards the original channel diameter D in accordance with the relation (2) above. The second z-coordinate z₂ is defined as the first location along the channel, where the channel narrows down to its original, overall diameter D. In practical terms this means that the geometry should be designed to minimize the change in surface curvature as the channel narrows down. This will ensure that bubbles which have reached z₁ unfragmented, or which have been fragmented at z₁ into bubbles of non-critical length, will not be further fragmented during their passage along the second channel section, and will enter into the remaining, straight section of channel 3 unfragmented and remain unfragmented also there.

FIG. 6 shows the preferred embodiment of the invented micro-mixer. The two fluids 50, 51 are contained in the reservoirs 52, 53. The fluids are lead into the channels 54 and 55 respectively, where the tube is split into two branches 54a, 54b. The fluids flow at rates mainly regulated by the pressure difference driving the fluids, and the flow restrictors 56, 57 inserted into the channels (an additional flow restrictor may be inserted into channel 55). The flow restrictors have the property of being bubble restraining, like the pieces of capillary tubes with and tapered inlets as described above. This ensures that bubbles of gas arriving in the tubes 54a, 54b, are changed into sizes unable to clog the flow-path, like at the merging point 59 of the channels 54a, 54b, 55.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A device for mixing at least one first fluid and one second fluid in a micro-flow system, comprising:
at least two flow restrictors;
a first transfer conduit in fluid communication with said first fluid and a recipient; and
at least one second transfer conduit in fluid communication with said second fluid and a recipient, the second transfer conduit having at least two fluid outlets in fluid communication with said first transfer conduit,
where each of said outlets of said second transfer conduit is downstream and in fluid communication with the outlet of one of said flow restrictors, and wherein the flow restrictors are bubble-tolerant, being formed to prevent fragmentation of bubbles entering the flow restrictor into a bubble train consuming the pressure difference between the source and the recipient.

2. A device for mixing at least one first fluid and one second fluid in a micro-flow system, comprising:
at least two flow restrictors;
a first transfer conduit in fluid communication with said first fluid and a recipient; and
at least one second transfer conduit in fluid communication with said second fluid and a recipient, the second transfer conduit having at least two fluid outlets in fluid communication with said first transfer conduit,
where each of said outlets of said second transfer conduit is downstream and in fluid communication with the outlet of one of said flow restrictors, at least one of said restrictors comprising a body with an inlet face, an outlet face and a flow channel extending there between from an inlet to an outlet, the channel having over most of its length a substantially constant, minimum hydraulic diameter D=4 A/W wherein A is the minimum local cross-sectional area of the channel and W is the minimum local wetting perimeter of the channel, wherein the channel is smoothly widened at the inlet such that:
at distances z from the inlet face with 0<z<z₁, the channel has a hydraulic diameter D_{z}≧k*D wherein k≧1.3;
at distances z from the inlet face with z₁<z<z₂, the channel has a hydraulic diameter D_{z} with k*D≧D_{z}≧D; and
at distances z from the inlet face with z₂<z, the channel has a hydraulic diameter D_{z} with D_{z}≦1.02 D, except possibly for a similar widening of the channel at the outlet.

3. The device as in claim 2, wherein k≧2.

4. The device as in claim 2, wherein k≧3.

5. The device as in claim 2, wherein k≧4.

6. The device as in claim 2, for use in a flow system for delivering liquid of viscosity ƒ at a flow rate Q, wherein bubbles of gas may be present in the liquid whose movement in the channel requires a meniscus deformation governed by a frictional surface parameter α, wherein
$$k ⋆ D \geq \sqrt[3]{\frac{á {D}^{5}}{32 ç Q}} .$$

7. The device according to claim 1, wherein said second transfer conduit has one fluid inlet branching into at least two fluid outlets, and said flow restrictors are placed downstream the branching position and upstream each of the fluid outlets of the second transfer conduit.

8. The device according to claim 7, wherein said flow restrictors are capillary tubes.

9. The device according to claim 8, wherein said flow restrictors are glass capillary tubes.

10. An apparatus for mixing at least two fluids before delivering the mixed fluids to a recipient, the apparatus comprising reservoirs of liquids at higher pressure than the recipient, at least two flow restrictors as claimed in claim 1,
a first transfer conduit in fluid communication with a first of said reservoirs and the recipient,
at least one second transfer conduit in fluid communication with a second of said reservoirs, the second transfer conduit having at least two fluid outlets in fluid communication with said first transfer conduit,
where each of said outlets of said second transfer conduit is downstream and in fluid communication with the outlet of one of said flow restrictors, and the inlets of said flow restrictors being in fluid communication with the second of said reservoirs.

11. The device according to claim 1, wherein said device is in a system for analysing the contents of species in fluids.

12. A device for mixing fluids comprising flow restrictors having tapered inlets, wherein
$${\hat{o}}^{⋆} > {\hat{o}}_{bl}$$
with τ and τ* defined as above.

13. The device according to claim 2, wherein said second transfer conduit has one fluid inlet branching into at least two fluid outlets, and said flow restrictors are placed downstream the branching position and upstream each of the fluid outlets of the second transfer conduit.

14. The device according to claim 13, wherein said flow restrictors are capillary tubes.

15. The device according to claim 14, wherein said flow restrictors are glass capillary tubes.

16. An apparatus for mixing at least two fluids before delivering the mixed fluids to a recipient, the apparatus comprising reservoirs of liquids at higher pressure than the recipient, at least two flow restrictors as claimed in claim 2,
a first transfer conduit in fluid communication with a first of said reservoirs and the recipient,
at least one second transfer conduit in fluid communication with a second of said reservoirs, the second transfer conduit having at least two fluid outlets in fluid communication with said first transfer conduit,
where each of said outlets of said second transfer conduit is downstream and in fluid communication with the outlet of one of said flow restrictors, and the inlets of said flow restrictors being in fluid communication with the second of said reservoirs.

17. The device according to claim 2, wherein said device is in a system for analysing the contents of species in fluids.
